(19) United States
(12) Patent Application Publication
(10) Pub. No.: US 2015/0116145 A1
(43) Pub. Date: Apr. 30, 2015

(54) INTERFERENCE MAP FOR GNSS DEVICE

(71) Applicant: JAVAD GNSS, Inc., San Jose, CA (US)

(72) Inventor: Javad ASHJAEE, Saratoga, CA (US)

(21) Appl. No.: 14/508,862

(22) Filed: Oct. 7, 2014

Related U.S. Application Data
(60) Provisional application No. 61/897,741, filed on Oct. 30, 2013.

(51) Int. Cl. G01S 19/21; G01S 19/03

(52) U.S. Cl. CPC G01S 19/21; G01S 19/03
USPC 342/357.4

(57) ABSTRACT

Systems and methods for aggregating interference data and generating visual representations of the interference data are provided. In one example method, interference data may be received from multiple GNSS receivers positioned at various geographical locations. A request for a visual representation of interference at a location may be received. In response to the request, a visual representation of interference at the requested location may be generated based on at least a portion of the received interference data. The visual representation may include a map overlaid with visual indicators of interference indicating a location and magnitude of the interference. The visual representation of interference at the requested location may then be transmitted to a computing device requesting the representation.

### CROSS-REFERENCE TO RELATED APPLICATION

This application claims priority from U.S. Provisional Ser. No. 61/897,741, filed on Oct. 30, 2013, entitled INTERFERENCE MAP FOR GNSS DEVICE, which is hereby incorporated by reference in its entirety for all purposes.

### FIELD

The present disclosure relates generally to Global Navigation Satellite System (GNSS) devices and, more specifically, to aggregating and generating visual representations of in-band interference for GNSS receivers.

### BACKGROUND

In most countries, the government regulates radio frequency bands of the electromagnetic spectrum by allocating portions of the frequency spectrum to different transmitting systems, such as GNSS, television broadcast, FM and AM radio, and radar systems. As such, to receive signals from these systems, specific receivers configured to receive signals within the allocated frequencies are needed. For example, an FM receiver configured to receive signals within the FM radio frequency band is needed to receive FM radio signals and a television receiver configured to receive signals within the television broadcast frequency band is needed to receive television signals. Similarly, a GNSS receiver configured to receive signals within the GNSS frequency band is needed to receive GNSS signals.

Typically, a filter is used to selectively receive signals within an allocated frequency band of interest. For example, when tuning a radio to a radio station, a filter can be adjusted to accept signals from that radio frequency band and reject signals from other bands. While these filters are useful for filtering signals outside the frequency band of interest, their ability to filter in-band interference may be limited. In-band interference may be caused by harmonics consisting of residual signals from other nearby transmitting systems. The damaging effect of in-band interference depends on the strength of the harmonic signals relative to the desired signal. For example, if an FM receiver is located far from the transmitting FM station, but very close to another transmitting system, the harmonics of the nearby transmitting system may disturb the reception of the desired FM signal from the transmitting FM station.

GNSS receivers may be particularly susceptible to in-band interference for two reasons. First, GNSS satellites are approximately 20,000 kilometers away from GNSS receivers, while many transmitting systems that could generate interfering harmonics are located much closer to the GNSS receivers. Second, the GNSS frequency band is much wider than other allocated bands, making it more likely that a harmonic will fall within the GNSS band. For example, the bandwidth of FM radio stations is approximately 15 KHz, while the bandwidth of each of the three GPS bands is about 20 MHz.

While harmonics within the band of a desired FM radio station may manifest as audible noise to the listener, harmonics within a GNSS band may cause inaccurate position measurements. In particular, a GNSS receiver receiving noisy measurements may prevent Real-time Kinematic (RTK) float solutions from converging to accurate fixed position solutions. Furthermore, a particularly strong harmonic in the vicinity of a GNSS receiver may cause total blockage of one or more of the GNSS bands.

Today, the number of applications utilizing GNSS information is rapidly increasing. As such, identifying in-band interference within GNSS frequency bands is becoming increasingly important. While devices, such as spectrum analyzers, are available for determining when a position measurement is experiencing in-band interference, it is often difficult to determine the location and geographical range of the interference.

### SUMMARY

Systems and methods for aggregating interference data and generating visual representations of the interference data are provided. In one example method, interference data may be received from multiple GNSS receivers positioned at various geographical locations. A request for a visual representation of interference at a location may be received. In response to the request, a visual representation of interference at the requested location may be generated based on at least a portion of the received interference data. The visual representation may include a map overlaid with visual indicators of interference indicating a location and magnitude of the interference. The visual representation of interference at the requested location may then be transmitted to a computing device requesting the representation.

### BRIEF DESCRIPTION OF THE DRAWINGS

FIG. 1 illustrates an example system for aggregating and generating visual representations of in-band interference for GNSS receivers according to various examples.

FIG. 2 illustrates an exemplary process for aggregating and generating visual representations of in-band interference for GNSS receivers according to various examples.

FIG. 3A illustrates an example graphical representation of in-band interference for GNSS receivers according to various examples.

FIG. 3B illustrates another example graphical representation of in-band interference for GNSS receivers according to various examples.

FIG. 4 illustrates another example graphical representation of in-band interference for GNSS receivers according to various examples.

FIG. 5 illustrates a block diagram of an example GNSS receiver and CPU according to various examples.

FIG. 6 illustrates a logic diagram showing the relationships between components of a handheld GNSS device according to various examples.

In the following description, reference is made to the accompanying drawings which form a part thereof, and which illustrate several embodiments of the present disclosure. It is understood that other embodiments may be utilized and structural and operational changes may be made without departing from the scope of the present disclosure. The use of the same reference symbols in different drawings indicates similar or identical items.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention as claimed. Thus, the various embodiments are not intended to be limited to the examples described herein and shown, but are to be accorded the scope consistent with the claims.

The present disclosure relates to systems and methods for aggregating interference data and generating visual representations of the interference data. In one example method, interference data may be received from multiple GNSS receivers positioned at various geographical locations. A request for a visual representation of interference at a location may be received. In response to the request, a visual representation of interference at the requested location may be generated based on at least a portion of the received interference data. The visual representation may include a map overlaid with visual indicators of interference indicating a location and magnitude of the interference. The visual representation of interference at the requested location may then be transmitted to a computing device requesting the representation.

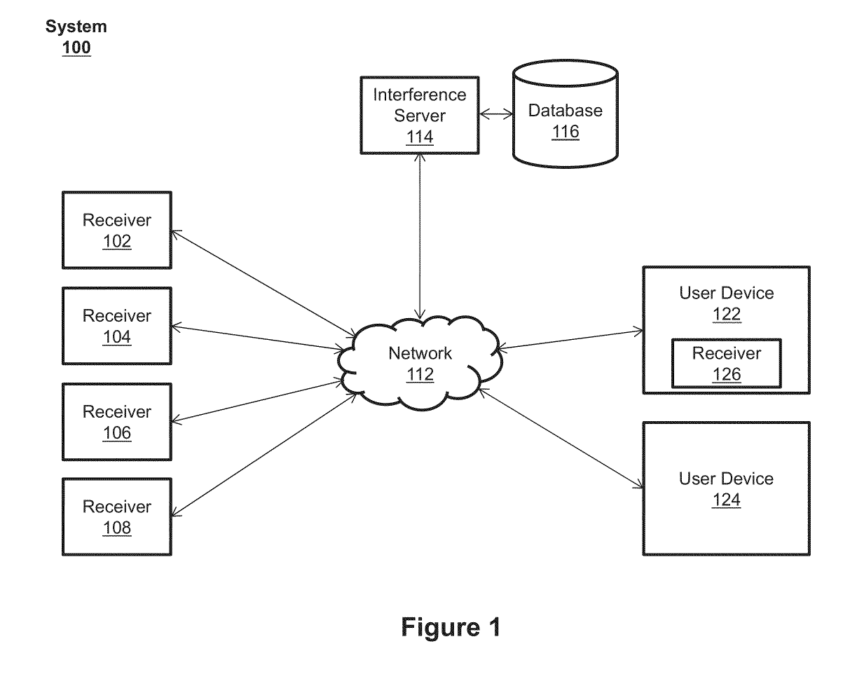

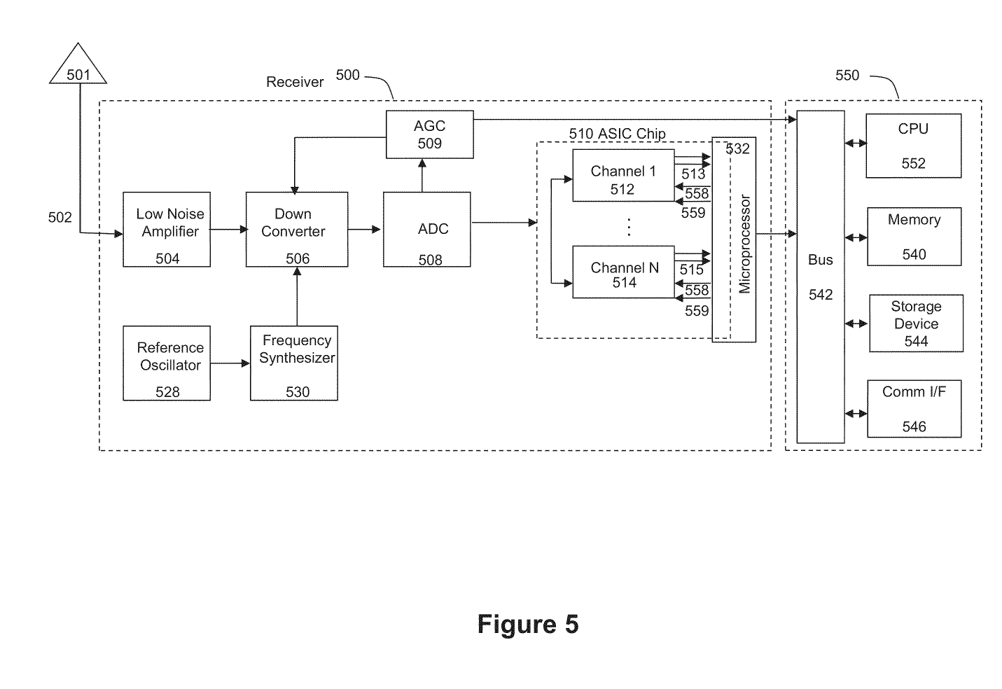

FIG. 1 illustrates an example system 100 for aggregating interference data and generating visual representations of the interference data according to various examples. System 100 may include any number of GNSS receivers 102, 104, 106, and 108 configured to measure a location, magnitude, frequency, and time of interference experienced by the receiver. These receivers may be positioned at various locations where it may be desirable to measure GNSS signal interference. These receivers may be stationary or mobile receivers configured to measure interference intermittently, continuously, periodically, or at any other desired interval of time. A more detailed example of a GNSS receiver that can be used as receivers 102, 104, 106, and 108 is described below with respect to FIG. 5.

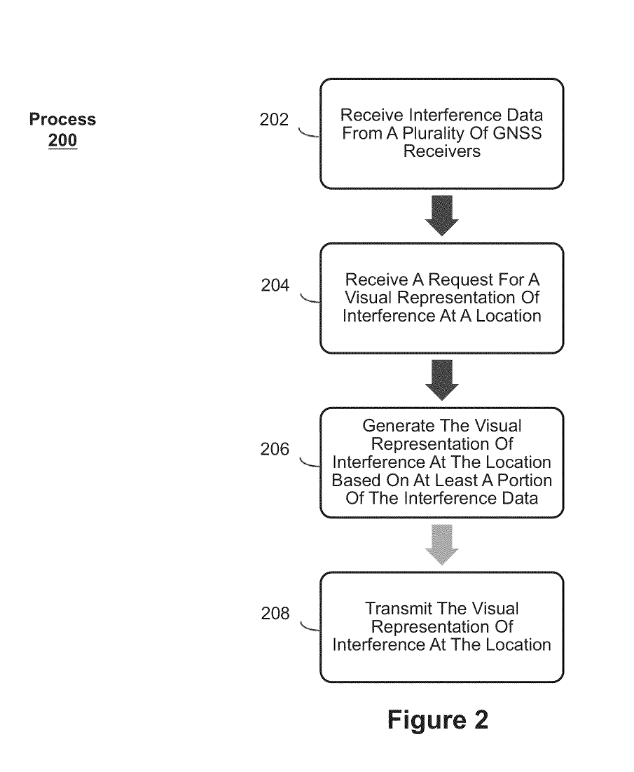

System 100 may further include an interference server 114 coupled to receive interference data from receivers 102, 104, 106, and 108 via network 112, which may include the Internet, an intranet, or any other wired or wireless public or private network. GNSS receivers 102, 104, 106, and 108 may be configured to transmit interference data to interference server 114 intermittently, continuously, periodically, or at any other desired interval of time. Interference server 114 may be coupled to an interference database 116 for storing the received interference data. In some examples, database 116 may be included within server 114 while, in other examples, database 116 may be external to interference server 114. As discussed in greater detail below with respect to FIGS. 2-4, interference server 114 may include a computer processor and computer-executable instructions for receiving interference data, generating a visual representation of the interference data on a map that can be displayed on a computing device, and transmitting the visual representation to one or more remote computing devices.

System 100 may further include any number of user devices 122 and 124, which may include any computing device, such as a desktop computer, laptop computer, tablet computer, mobile smart phone, portable GNSS device, or the like. User devices 122 and 124 may be coupled to receive interference data from interference server 114 via network 112. The interference data may include locations, frequencies, times, and magnitudes of the interference or a visual representation of the interference data overlaid on a map. The interference data or the visual representation of the interference data may be displayed on a display of user devices 122 and 124 to be viewed by the users of the devices. In some examples, one or more of the user devices may include a GNSS receiver similar or identical to receivers 102, 104, 106, and 108. For example, user device 122 may be a portable GNSS device having a GNSS receiver 126. In these examples, user device 122 and receiver 126 may be configured to measure a location, frequency, time, and magnitude of interference experienced by the receiver 126 and transmit the interference data to interference server 114.

In some examples, the processing functionality of interference server 114 and storage capability of database 116 may be implemented using a processor and storage located within one of user devices 122 and 124. In yet other examples, interference server 114 and database 116 may be configured to receive and store interference data from some or all of sensors 102, 104, 106, 108, and 126. Interference server 114 may be further configured to transmit the stored interference data to one or more user devices 122 and 124. Using the received interference data, user devices 122 and 124 may be configured to generate the visual representations of the interference data.

FIG. 2 illustrates an exemplary process 200 for aggregating interference data and generating visual representations of the interference data according to various examples. In some examples, process 200 can be performed using system 100. At block 202, interference data may be received from one or more GNSS receivers. The interference data may include locations, frequencies, times, and magnitudes of interference detected by the GNSS receivers. In some examples, the interference data may also indicate the absence of interference (e.g., interference having a magnitude of 0 or other value below a threshold amount). The locations may be expressed in any desired coordinate system, such as Earth-based coordinate systems WGS84, ECEF, ENU, and the like. In some examples, an interference server similar or identical to interference server 114 may receive interference data from one or more GNSS receivers similar or identical to GNSS receivers 102, 104, 106, and 108. The interference server may alternatively or additionally receive interference data from other computing devices, such as a portable GNSS device 122 having a GNSS receiver 126 configured to measure a magnitude of interference experienced by the receiver. The interference data may be stored in a local or remote database similar or identical to database 116.

In other examples, a computing device similar or identical to user devices 122 and 124 may receive, at block 202, interference data from one or more GNSS receivers or from an interference server similar or identical to interference server 114. The interference data may then be stored in the computing device.

At block 204, a request for a visual representation of interference at a location may be received. For example, the interference server may receive a request for a visual representation of interference from a computing device similar or identical to user devices 122 and 124. In some examples, the request may include coordinates or other representation (e.g., city name, landmark name, etc.) of the location of the requested visual representation. The location may be entered into the user device by the user or, in some examples, may be the position of the user device as determined by a GNSS receiver in the user device.

In other examples, a computing device similar or identical to user devices 122 and 124 may receive, at block 204, the request for a visual representation of the interference data at a location. The request may be received from a user of the device via an input device (e.g., keyboard, touch sensitive display, or the like) or may be received from another computing device via network 112.

interference data from one or more GNSS receivers or from an interference server similar or identical to interference server 114. The interference data may then be stored in the computing device.

At block 206, a visual representation of interference at the location requested at block 206 may be generated based on at least a portion of the interference data received at block 202. The visual representation of interference at the location may include a geographical map of the requested location with one or more visual indicators of interference overlaid thereon. The visual indicators of interference may be positioned at locations on the map corresponding to the real world location of the interference as determined from location information contained in the interference data. Additionally, the visual indicators may extend over all portions of the map that experience interference or a threshold level of interference. In some examples, the visual indicators of the interference may further indicate a magnitude of the interference. For example, the visual indicators of the interference data may include a numerical value representing a magnitude of interference (e.g., a larger value may represent interference having a greater magnitude), a circle or other shape whose size represents a magnitude of interference (e.g., a larger shape may indicate interference having a greater magnitude), a color shading having a color representing a magnitude of interference (e.g., green representing low magnitude interference, yellow representing intermediate magnitude interference, red representing large magnitude interference, etc.) or representing a magnitude of the spectrum of the interference. In this way, the visual representation of interference at the location may show a user a geographical representation of the location, the locations and coverage of interference at the requested location, and the magnitude of the interference. The visual representation may be easy to understand and allow the user to change the location of where they are taking a position measurement, perform the position measurement at a different time to avoid the interference, implement a desired in-band interference reduction technique, or understand why the GNSS device may be taking longer to find a fixed RTK solution.

In some examples, the interference data may be time-stamped and more recent interference data may override or replace older interference data. For example, if an older interference data entry indicates interference having a high magnitude at location X, but a recent entry of interference data indicates no interference at location X, the interference server may use the more recent interference data to generate the visual representation of interference. This can be helpful in situations where the location or amount of interference changes over time. In other examples, the interference server may average interference data values when multiple values exist. In yet other examples, the interference may be weighted based on the age of the data. For example, a decay algorithm may be used to de-weight older interference data entries. In yet other examples, a combination of the above may be used.

In other examples, a computing device similar or identical to user devices 122 and 124 may generate, at block 206, the visual representation of the interference data at a location in a manner similar to that described above for the interference server. In these examples, the computing device may be configured to perform the functions described above for the interference server. For example, the computing device may instead receive the interference data from the GNSS receivers at block 202 and receive a request for the visual representation of interference at block 204. At block 206, the computing device may generate the visual representation using the received interference data. The maps used to generate the visual representation may be included within the computing device during manufacture or may be downloaded from the interference server or a separate map server. In other examples, the interference server may be configured to aggregate interference data received from multiple GNSS receivers at block 202. In these examples, the computing device may receive a request for the visual representation of interference at block 204 and request the interference data from the interference server. In response to receiving the requested interference data, the computing device may generate, at block 206, the visual representation of interference in a manner similar to that described above with respect to the interference server. In yet other examples, the computing device may be manufactured with maps and interference data preloaded for use when generating the visual representations of interference.

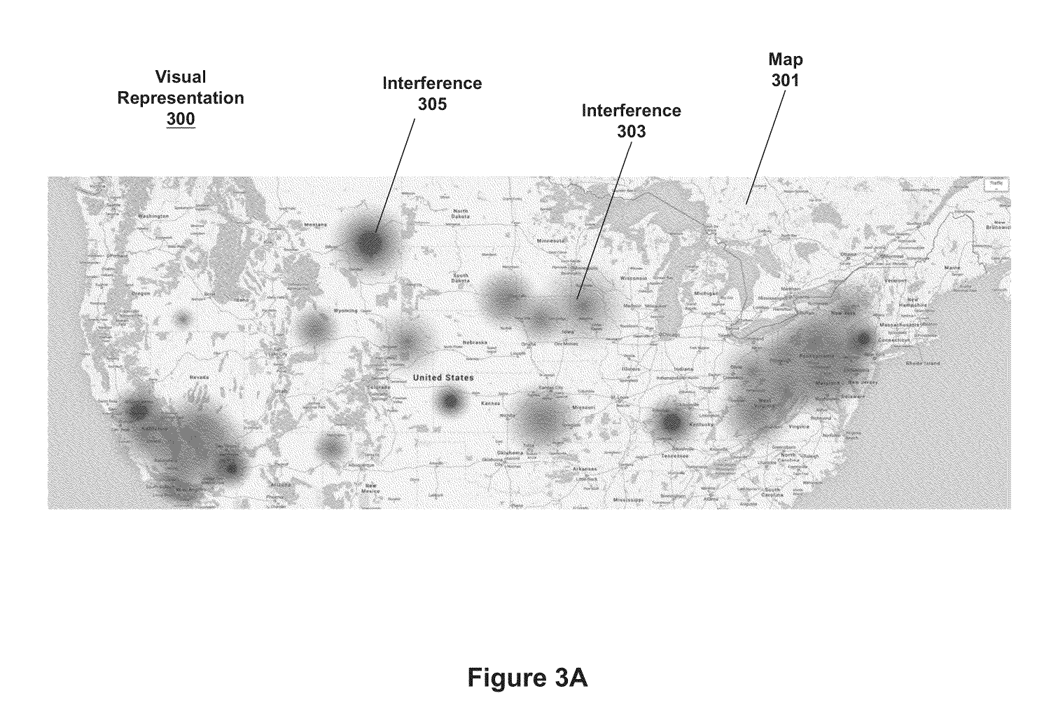

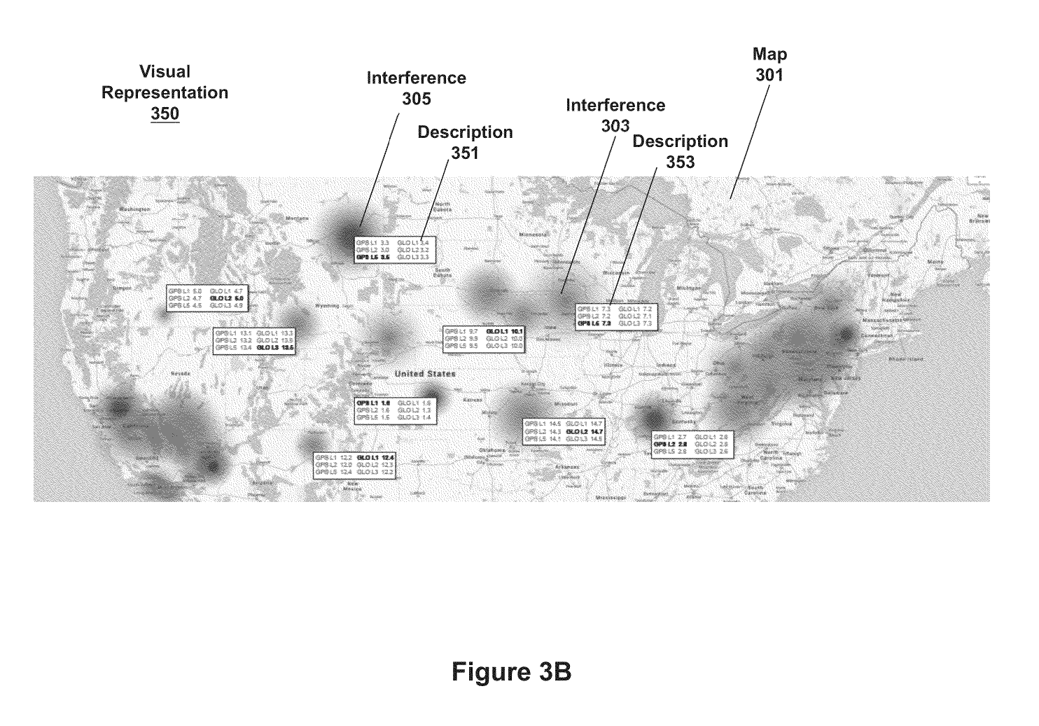

FIG. 3A illustrates an example visual representation 300 of interference at a requested location. In the illustrated example, the requested location is the United States. As such, visual representation 300 may include a map 301 of the United States having visual indicators of interference 303 and 305 (including others that are unmarked) overlaid thereon. In this example, the visual indicators may include colored shadings overlaid on portions of map 301 corresponding to locations of the detected interference. The darkness of the visual indicators may indicate a magnitude of the interference such that darker visual indicators represent interference having greater magnitudes. Thus, visual indicators of interference 303 may represent interference having an intermediate magnitude, while visual indicator of interference 305 may represent interference having a large magnitude.

FIG. 3B illustrates another example visual representation 350 of interference at a requested location that is similar to visual representation 300. However, visual representation 350 further includes textual descriptions 351 and 353 of the interference represented by visual indicators 301 and 303, respectively. In the illustrated example, the textual descriptions include the names of various GNSS frequency bands (e.g., GPS L1, GPS L2, GPS L5, GLO L1, GLO L2, and GLO L3) along with a numerical value representing the magnitude of interference detected for each of the listed frequency bands. In other examples, other information, such as time, location coordinates, or the like, may be included within the textual descriptions.

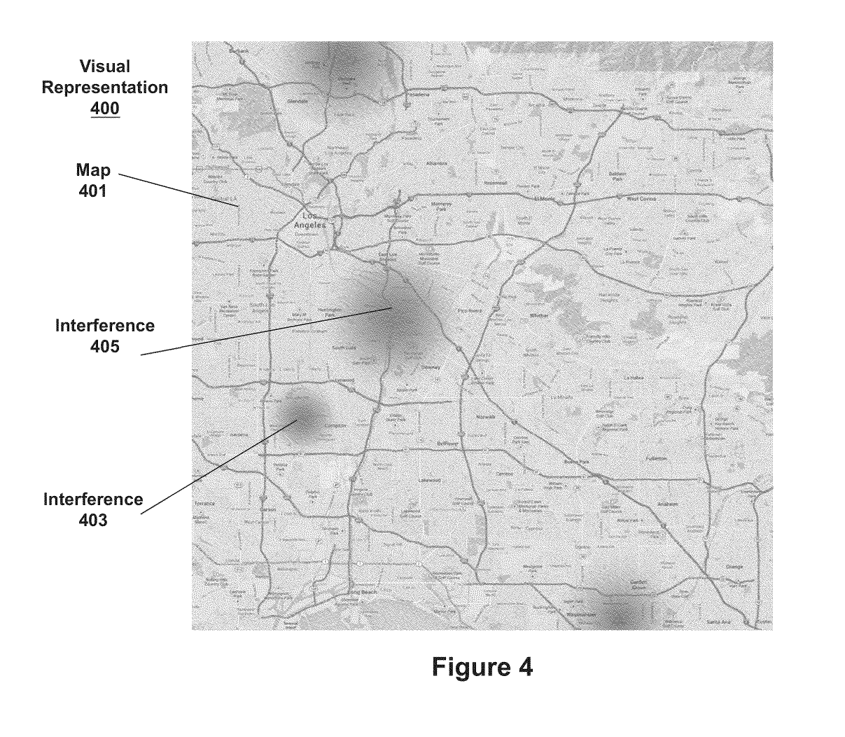

FIG. 4 illustrates another example visual representation 400 of interference at a requested location. In the illustrated example, the requested location is Los Angeles. As such, visual representation 400 may include a map 401 of Los Angeles having visual indicators of interference 403 and 405 (including others that are unmarked) overlaid thereon. In this example, similar to the examples of FIGS. 3A and 3B, the visual indicators may include colored shadings overlaid on portions of map 401 corresponding to locations of the detected interference. The darkness of the visual indicators may indicate a magnitude of the interference such that darker visual indicators represent interference having greater magnitudes. Thus, visual indicator of interference 403 may represent interference having an intermediate magnitude, while visual indicator of interference 405 may represent interference having a similar magnitude but that covers a larger geographical area.

Referring back to FIG. 2, at block 208, the visual representation of the interference at the location may be transmitted. For example, the visual representation generated at block 206 may be transmitted by the interference server to the user device that transmitted the request received at block 204. In other examples, the visual representation may be transmitted to another computing device. Once received, the visual representation of the interference at the location may be displayed by the computing device to be viewed by the user of the device.

While the blocks of FIG. 2 are shown in a particular order, it should be understood that the blocks may be performed in any order and that some of the blocks need not be performed. For example, the interference data received at block 202 may be received at any time during process 200. The received interference data may be stored in the interference database and used to generate subsequently requested visual representations of interference. In this way, the interference data used to generate the visual representations may be updated intermittently, continuously, periodically, or at any desired interval to provide users with recently updated or real-time interference data. In other examples, blocks 204, 206, and 208 may be repeated when a user requests a resized visual representation of the interference or changes a location of the visual representation of interference.

FIG. 5 illustrates an example GNSS receiver 500 according to various examples. GNSS receiver 500 may be used as any of receivers 102, 104, 106, 108, and 126 in system 100. GNSS receiver 500 may be coupled to receive GNSS signals 502 from a GNSS antenna 501. GNSS signals 502 may contain two pseudo-noise (“PN”) code components, a coarse code, and a precision code residing on orthogonal carrier components, which may be used by GNSS receiver 500 to determine the position of the GNSS receiver. For example, a typical GNSS signal 502 includes a carrier signal modulated by two PN code components. The frequency of the carrier signal may be satellite specific. Thus, each GNSS satellite may transmit a GNSS signal at a different frequency.

GNSS receiver 500 may include a low noise amplifier 504, a reference oscillator 528, a frequency synthesizer 530, a down converter 506, an automatic gain control (AGC) 509, and an analog-to-digital converter (ADC) 508. These components may perform amplification, filtering, frequency down-conversion, and sampling. The reference oscillator 528 and frequency synthesizer 530 may generate a frequency signal to down convert the GNSS signals 502 to baseband. It should be understood that the down converter 506 may convert the GNSS signals 502 to an intermediate frequency depending on the entire receiver frequency plan design and available electronic components. The ADC 508 may then converts the GNSS signals 502 to a digital signal by sampling multiple repetitions of the GNSS signals 502.

The GNSS receiver 500 may also include multiple GNSS channels, such as channels 512 and 514. It should be understood that any number of channels may be provided. The GNSS channels 512 and 514 may each contain a demodulator to demodulate a GNSS PN code contained in ADC signal 509, a PN code reference generator, a numerically controlled oscillator (code NCO) to drive the PN code generator as well as a carrier frequency demodulator (e.g. a phase detector of a phase locked loop—PLL), and a numerically controlled oscillator to form a reference carrier frequency and phase (carrier NCO). In one example, the numerically controlled oscillator (code NCO) of channels 512 and 514 may receive code frequency/phase control signal 558 as input. Further, the numerically controlled oscillator (carrier NCO) of channels 512 and 514 may receive carrier frequency/phase control signal 559 as input. Code frequency/phase control signal 558 and carrier frequency/phase control signal 559 are described in greater detail below.

In one example, the processing circuitry for the GNSS channels may reside in an application specific integrated circuit (“ASIC”) chip 510. When a corresponding frequency is detected, the appropriate GNSS channel may use the embedded PN code to determine the distance of the receiver from the satellite. This information may be provided by GNSS channels 512 and 514 through channel output vectors 513 and 515, respectively. Channel output vectors 513 and 515 each contain four signals forming two vectors—inphase I and quadriphase Q which are averaged signals of the phase loop discriminator (demodulator) output, and inphase dI and quadriphase dQ—averaged signals of the code loop discriminator (demodulator) output.

GNSS receiver 500 may be operably coupled to a computing system 550 for detecting interference in signals 502 received by GNSS receiver 500. Processor-executable instructions for detecting interference may be stored in memory 540 of computing system 550. The instructions, executable by CPU 552, may include instructions for scanning and identifying the shape and frequencies of interference. The computing system 550 may include one or more processors, such as a CPU 552. However, those skilled in the relevant art will also recognize how to implement the current technology using other computer systems or architectures. CPU 552 can be implemented using a general or special purpose processing engine such as, for example, a microprocessor, microcontroller or other control logic. In this example, CPU 552 is connected to a bus 542 or other communication medium. The CPU 552 may be operably connected to microprocessor 532, via the bus 542, to receive the channel output vectors 513 and 515.

The interference detection instructions stored in memory 540 may include instructions for generating an energy spectrum of one or more GNSS frequency bands. The memory 540 may be integrated with GNSS receiver 500. Memory 540 may be read only memory (“ROM”) or other static storage device coupled to bus 542 for storing static information and instructions for CPU 552. Memory 540 may also be random access memory (RAM) or other dynamic memory, for storing information and instructions to be executed by CPU 552. Memory 540 also may be used for storing temporary variables or other intermediate information during execution of instructions to be executed by CPU 552.

An information storage device 544 may be connected to GNSS receiver 500. The information storage device may include, for example, a media drive (not shown) and a removable storage interface (not shown). The media drive may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media may include, for example, a hard disk, floppy disk, magnetic tape, optical disk, CD or DVD, or other fixed or removable medium that is read by and written to by media drive. As these examples illustrate, the storage media may include a non-transitory computer-readable storage medium having stored therein particular computer software or data.

In other examples, information storage device 544 may include other similar instrumentalities for allowing computer programs or other instructions or data to be loaded into computing system 550. Such instrumentalities may include, for example, a removable storage unit (not shown) and an interface (not shown), such as a program cartridge and cartridge interface, a removable memory (for example, a flash memory or other removable memory module) and memory slot, and other removable storage units and interfaces that allow software and data to be transferred from the removable storage unit to computing system 550.

Computing system 550 can also include a communications interface 546. Communications interface 546 can be used to allow software and data to be transferred between computing system 550 and external devices. For example, communications interface 546 may be used to transmit interference data to interference server 114, to transmit requests for visual representations of interference to interference server 114, and to receive visual representations of interference from interference server 114. Examples of communications interface 546 can include a modem, a network interface (such as an Ethernet or other NIC card), a communications port (such as for example, a USB port), a PCMCIA slot and card, etc. Software and data transferred via communications interface 546. Some examples of a communication interface 546 include a phone line, a cellular phone link, an RF link, a network interface, a local or wide area network, and other communications channels.

In this document, the terms “computer program product” and “non-transitory computer-readable storage medium” may be used generally to refer to media such as, for example, memory 540, storage media, or removable storage unit. These and other forms of computer-readable media may be involved in providing one or more sequences of one or more instructions to CPU 552 for execution. Such instructions, generally referred to as “computer program code” (which may be grouped in the form of computer programs or other groupings), when executed, enable the computing system 550 to perform features or functions of embodiments of the current technology.

In one example where the elements are implemented using software, the software may be stored in a computer-readable medium and loaded into computing system 550 using, for example, removable storage drive, media drive, or communications interface 546. The control logic (in this example, software instructions or computer program code), when executed by the CPU 552, causes the CPU 552 to perform the functions of the technology as described herein. For example, the instructions, when executed by CPU 552, may cause CPU 552 to perform process 200.

The signal strength data used for the interference detection may be generated, for example, by calculating the square root of the sum of the squares of the I (in-phase) and Q (quadrature-phase) components of the GNSS signals received within the GNSS frequency band. More particularly, the numerically controlled oscillator (NCO) is adjusted to measure the signal strength, or energy, across the frequencies within the allocated GNSS band in steps. For example, measurements may be taken at every 10 kHz with a particular GNSS band. The I and Q components are then squared and summed. Energy may be calculated by taking the square root of that sum.

The interference detection instructions may also include instructions for generating an indication of magnitude of the in-band interference. The indication of magnitude of the in-band interference may be generated in two different ways, for example. The first method of providing the indication of magnitude may be determined by examining the amplification of the analog GNSS signals during signal processing. The second method of providing the indication of magnitude may be by determining the satellite signal quality loss due to the in-band interference. Signal quality refers to, without limitation, signal-to-noise (S/N), carrier interference, and other signal quality metrics.

The first method for determining the indication of magnitude is based on analyzing the analog signal before amplification in the AGC 509 (FIG. 5). Thus, the indication of magnitude can be determined by comparing the actual amplification magnitude of the AGC 509 with the nominal amplification magnitude (when no interference exists). As mentioned above, having an indication of magnitude of the in-band interference will allow a user to adjust the amplification of the GNSS signals to avoid saturation. In other words, it will allow a user to use a minimum amount of amplification to avoid saturation of a signal.

The second method for determining an indication of magnitude of the in-band interference may include determining a signal quality loss due to the in-band interference by analyzing signal quality ratio of the GNSS signals after the GNSS signals are digitized and processed (code and carrier correlations). A signal quality metric refers to, without limitation, signal-to-noise (S/N), carrier interference, and other signal quality metrics. Satellite S/N loss may be determined by comparing the actual measured S/N of each signal of each satellite with the nominal S/N at the particular elevation angle where the measurement is taken by the GNSS handheld device. The deviations between the actual measured S/N and the nominal S/N at the particular elevation angle for the satellites may be averaged and used as interference data. Nominal S/N for particular elevation angles are known and stored in memory 540.

In this way, the signal strength data generated by the CPU 552 executing the instructions stored in memory 540 may be used to detect any-band interference within one or multiple GNSS frequency bands. Because the down-conversion applied to the incoming RF signals is known, the frequency axis of the spectrum display can be calibrated using known techniques to indicate the baseband RF frequencies even though the actual signal analyzed by the CPU 552 is a down-converted version of the baseband signal. The signal strength data determined by CPU 552 may be stored in storage device 544 or transmitted to an external device or database using communications interface 546. A more detailed description of detecting interference is provided in U.S. Patent Publication No. 2012/0229333 filed Sep. 8, 2011, assigned to the assignee of the present disclosure, which is incorporated herein by reference in its entirety for all purposes.

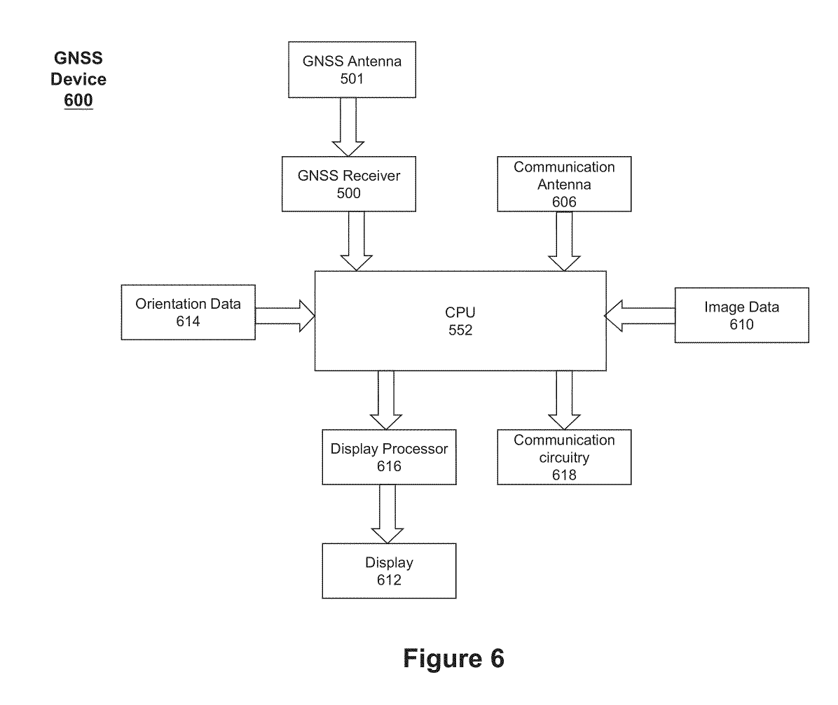

As mentioned above, one or more of the user devices 122 and 124 of system 100 may include a portable GNSS device 600. FIG. 6 illustrates an exemplary logic diagram showing the relationships between the various components of a handheld GNSS device 600. In one example, GNSS antenna 501 may send position data received from GNSS satellites to GNSS receiver 500. GNSS receiver 500 may convert the received GNSS satellite signals into Earth-based coordinates, such as WGS84, ECEF, ENU, and the like. GNSS receiver 500 may further send the coordinates to CPU 552 for processing along with position assistance data received from communication antenna 606. Orientation data 614 from orientation sensors within the GNSS handheld device 600 may also be sent to CPU 552. Orientation data 614 may include pitch and roll data from orientation sensors such as pitch horizon sensors and roll horizon sensors, for example. Image data 610 from video or still camera may also be sent along to the CPU 552 with the position data received by the GNSS antenna 501, positioning assistance data received by communication antenna 606, and orientation data 614. CPU 552 processes the data to determine the position of a point of interest and provides the position data to the display processor 616. The display processor 616 provides display data to be displayed on display 612. Further, CPU 552 may process received visual representations of interference from interference server 114 and provide the visual representation to display processor 616 for displaying on display 612. A user looking at the display 612 may view the locations and magnitudes of in-band interference.

A more detailed description of an example portable GNSS device that may be used for one or more of user devices 122 and 124 is provided in U.S. Pat. No. 8,125,376 filed Aug. 30, 2010, assigned to the assignee of the present disclosure, which is incorporated herein by reference in its entirety for all purposes.

It will be appreciated that, for clarity purposes, the above description has described embodiments with reference to different functional units and processors. However, it will be apparent that any suitable distribution of functionality between different functional units, processors, or domains may be used. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Furthermore, although individually listed, a plurality of means, elements, or method steps may be implemented by, for example, a single unit or processor. Additionally, although individual features may be included in different claims, these may possibly be advantageously combined, and the inclusion in different claims does not imply that a combination of features is not feasible or advantageous. Also, the inclusion of a feature in one category of claims does not imply a limitation to this category, but rather the feature may be equally applicable to other claim categories, as appropriate.

Although a feature may appear to be described in connection with a particular embodiment, one skilled in the art would recognize that various features of the described embodiments may be combined. Moreover, aspects described in connection with an embodiment may stand alone.

What is claimed is:

1. A computer-implemented method for aggregating interference data and generating a visual representation of the interference data, the computer-implemented method comprising:
receiving, one or more processors, interference data from a plurality of GNSS receivers;
receiving, by the one or more processors, a request for a visual representation of interference at a location; and
generating the visual representation of interference at the location based on at least a portion of the interference data, wherein the visual representation of interference comprises a map overlaid with visual indicators of interference.

2. The computer-implemented method of claim 1, wherein the interference data comprises a location, frequency, time, and magnitude of interference from a plurality of interference sources.

3. The computer-implemented method of claim 1, wherein the request is received from a portable GNSS device.

4. The computer-implemented method of claim 1, wherein the visual indicators of interference comprises numerical values positioned on the map at locations of interference from interference sources represented by the visual indicators, wherein the numerical values represent magnitudes of the interference from the interference sources.

5. The computer-implemented method of claim 1, wherein the visual indicators of interference comprises shapes positioned on the map at locations of interference from interference sources represented by the visual indicators, wherein sizes of the shapes represent magnitudes of the interference from the interference sources.

6. The computer-implemented method of claim 1, wherein the visual indicators of interference comprises colored shadings positioned on the map at locations of interference from interference sources represented by the visual indicators, wherein colors of the colored shadings represent magnitudes of the interference from the interference sources.

7. The computer-implemented method of claim 1, wherein the interference data is time-stamped with a time that the interference data was generated.

8. The computer-implemented method of claim 7, wherein newer interference data is weighted more heavily than older interference data when generating the visual representation of interference at the location.

9. The computer-implemented method of claim 1, wherein a GNSS receiver of the plurality of GNSS receivers is included within a portable GNSS device.

10. The computer-implemented method of claim 1, wherein the interference data is stored in an interference database, and wherein the method further comprises updating the interference database with intermittent or continuous updates from at least one of the plurality of GNSS receivers.

11. A system for aggregating interference data and generating a visual representation of the interference data, the system comprising:
an interference database for storing interference data; and
one or more processors operably coupled to the interference database, wherein the one or more processors are configured to:
receive interference data from a plurality of GNSS receivers;
receive a request for a visual representation of interference at a location; and
generate the visual representation of interference at the location based on at least a portion of the interference data, wherein the visual representation of interference comprises a map overlaid with visual indicators of interference.

12. The system of claim 11, wherein the interference data comprises a location, frequency, time, and magnitude of interference from a plurality of interference sources.

13. The system of claim 11, wherein the request is received from a portable GNSS device.

14. The system of claim 11, wherein the visual indicators of interference comprises numerical values positioned on the map at locations of interference from interference sources represented by the visual indicators, wherein the numerical values represent magnitudes of the interference from the interference sources.

15. The system of claim 11, wherein the visual indicators of interference comprises shapes positioned on the map at locations of interference from interference sources represented by the visual indicators, wherein sizes of the shapes represent magnitudes of the interference from the interference sources.

16. The system of claim 11, wherein the visual indicators of interference comprises colored shadings positioned on the map at locations of interference from interference sources represented by the visual indicators, wherein colors of the colored shadings represent magnitudes of the interference from the interference sources.

17. The system of claim 11, wherein the interference data is time-stamped with a time that the interference data was generated.

18. The system of claim 17, wherein newer interference data is weighted more heavily than older interference data when generating the visual representation of interference at the location.

19. The system of claim 11, wherein a GNSS receiver of the plurality of GNSS receivers is included within a portable GNSS device.

20. The system of claim 11, wherein the one or more processors are configured to update the interference database with intermittent or continuous updates from at least one of the plurality of GNSS receivers.
